(19) United States
(12) Patent Application Publication
(10) Pub. No.: US 2006/0226273 A1
(43) Pub. Date: Oct. 12, 2006

(54) Safety device for a vehicle occupant restraint system

(75) Inventors: Martin Prokscha, Schwaebisch Gmuend (DE); Joachim Biller, Lorch (DE); Wolfgang Holbein, Alfdorf (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/397,450

(22) Filed: Apr. 4, 2006

(30) Foreign Application Priority Data
Apr. 12, 2005 (DE) 10 2005 016 825.6

(51) Int. Cl. B65H 75/48; B60R 22/46

(52) U.S. Cl. 242/374; 280/806; 242/390.8

(57) ABSTRACT

A safety device for a vehicle occupant restraint system is able to be transferred from a first state into a second state. An impulse-controlled actor is provided to transfer the safety device from the first state into the second state. The actor is preferably a linear adjustment drive with a bistable lifting magnet (10).

### TECHNICAL FIELD

The invention relates to a safety device for a vehicle occupant restraint system.

### BACKGROUND OF THE INVENTION

In several safety relevant devices for vehicle occupant restraint systems, controlling and/or switching processes take place which necessitate a particular energy requirement.

It is an object of the invention to make possible a reduction of this energy requirement.

### BRIEF SUMMARY OF THE INVENTION

According to the invention, a safety device for a vehicle occupant restraint system is able to be transferred from a first state into a second state. An impulse-controlled actor is provided to transfer the safety device from the first state into the second state. Compared with actors which have been used hitherto, an impulse-controlled actor only requires a short current impulse in order to carry out a controlling or switching process. The switching power is thereby distinctly reduced.

Embodiments in which the actor is a linear adjustment drive with a bistable lifting magnet are particularly advantageous. In contrast to electromagnetic adjustment drives which have been used hitherto, a permanent current is not necessary for either the one or the other stable state of the bistable lifting magnet. Through the impulse control, the bistable lifting magnet is less intensively stressed thermally. Therefore, the adjustment drive can be smaller in construction. In particular, a small coil can be employed. Thus, in addition to the space required, also the costs on component parts in manufacture are reduced. A further advantage is to be seen in the fast switching time of a bistable lifting magnet.

For an impulse-controlled actor, in particular in the case of a construction with a bistable lifting magnet, the following possibilities for use, inter alia, are suggested in the field of safety belt systems:

In a comfort belt retractor, the winding spring force is set (e.g. lower force in the first position of the lifting magnet, higher force in the second position) by means of the impulse-controlled bistable lifting magnet.

In a belt buckle tensioner, the locking mimicry of the belt buckle is kept during the tensioning process through previous activation of the bistable lifting magnet.

The child safety function of a belt retractor, which was hitherto realized mechanically, is replaced by an actively controlled system with a bistable lifting magnet as controlling element.

In a belt retractor with an adjustable force limitation level, the activation or switching over to a different force level is carried out with the aid of a bistable lifting magnet.

Generally, an impulse-controlled actor provided according to the invention can be used in a belt retractor for blocking the belt spool in a case of restraint or, in an inverse design, for releasing the belt spool which is normally blocked.

In electric belt retractors which make possible a reversible belt tensioning, the bistable lifting magnet serves as an actor by which a blocking of the gear between the tensioning drive and the belt spool is achieved during the tensioning process. The blocking prevents a complete steering-in of a vehicle-sensitive blocking catch into blocking teeth of the belt spool, such that an unlocking operation of the tensioning drive can be avoided.

Another possibility for use occurs in an electric belt retractor for the coupling by which the electric motor, serving as tensioning drive, is coupled with the belt spool of the belt retractor for the purpose of pre-tensioning. In order to keep the timespan for coupling-in as short as possible, the bistable lifting magnet is used for the active controlling or closing of the coupling. For example, the electric motor and the bistable lifting magnet can be activated at the same time at the start of the tensioning phase, in order to close the connection between electric motor and belt spool.

Finally, the impulse-controlled actor can also serve to activate the locking in belt buckles, belt presenters or belt height adjusters, so that these assume a defined position in case of a tensioning of the belt.

Further possibilities for use are explained in the detailed description of the Figures.

### BRIEF DESCRIPTION OF THE DRAWINGS

FIGS. 1a, 1b show a bistable lifting magnet in a first position and in a second position, respectively;

FIG. 2 shows a side view of a friction coupling of an electric belt retractor according to a first embodiment;

FIG. 3 shows a side view of an electric belt retractor according to a second embodiment;

FIG. 4 shows a sectional view onto the coupling disc of the belt retractor of FIG. 3;

FIG. 5 shows a section along the plane V-V of FIG. 4;

FIG. 6 shows a block diagram for a safety device according to the invention in a vehicle occupant restraint system;

FIG. 7 shows a function diagram for a safety device according to the invention;

FIG. 8 shows the logic part of a control switching arrangement for an impulse-controlled actor; and

FIG. 9 shows the output part of a control switching arrangement for an impulse-controlled actor.

### DETAILED DESCRIPTION OF THE PREFERRED EMBODIMENTS

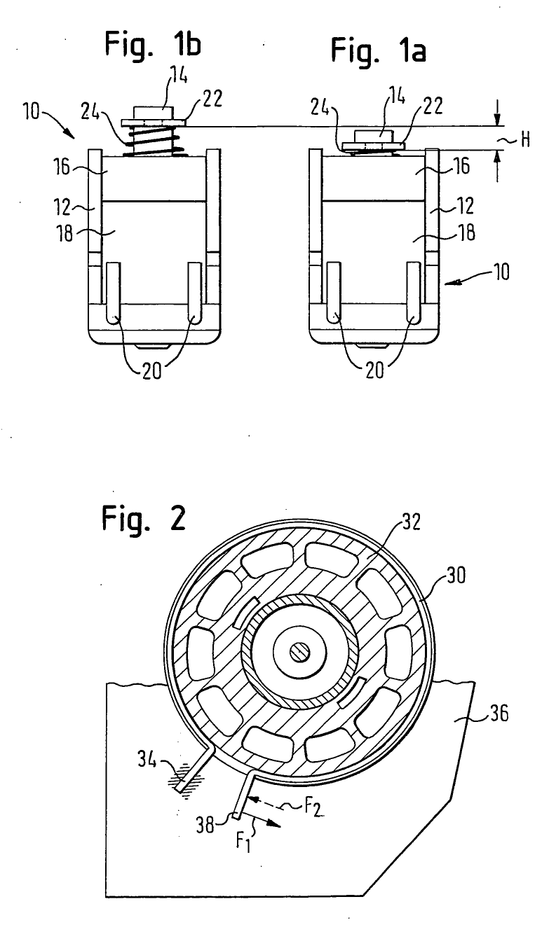

In FIGS. 1a and 1b a bistable lifting magnet 10 is illustrated, with a housing 12 and a plunger 14 which is guided so as to be movable linearly. A permanent magnet 16 and a coil 18 are arranged in the housing 12 which is approximately 1 cm in size. The coil 18 can be provided with current via connection lines 20. A compression spring 24 is arranged between a support surface 22 of the outer plunger end and the housing 12.

The bistable lifting magnet 10 has two stable end positions, namely with the plunger 14 retracted (FIG. 1a) and with the plunger 14 extended (FIG. 1b), which are designated below as the first position and the second position, respectively. The first position is stable, owing to the force of attraction between the plunger 14 and the permanent magnet 16; the second position is supported by the compression spring 24. The stroke H of the plunger 14 amounts to approximately 2 mm.

The controlling of the bistable lifting magnet 10 takes place by means of short current impulses. In order to move the bistable lifting magnet 10 from the first position into the second position, a current is briefly applied to the coil 18 in a direction which induces a magnetic field which neutralizes the magnetic field of the permanent magnet 16 and exerts a repelling effect on the plunger 14. In the second position, the force of the compression spring 24 serves as a holding force for the plunger 14, which is greater than the permanent magnet force of attraction which occurs again after the current impulse. A current impulse in the opposite direction induces a magnetic field which is equidirectional to the magnetic field of the permanent magnet 16. The force of attraction is sufficient in this case to overcome the holding force of the compression spring 24, such that the plunger 14 is retracted into the first position again.

The application of an impulse-controlled actor provided according to the invention in a friction coupling for an electric belt retractor, with which a reversible belt tensioning can be carried out, is explained below.

The essential parts of the friction coupling are shown in FIG. 2. A loop spring 30 is guided around a coupling disc 32. The loop spring 30 has a bent arm 34 which is supported securely against the frame 36 of the belt retractor. The other bent arm 38 is coupled to a bistable lifting magnet, as was previously described. In its first position, the bistable lifting magnet exerts a force F₁ and in its second position it exerts a force F₂ onto the arm 38.

Normally, the bistable lifting magnet is in the first position in which the loop spring 30 has no contact with the coupling disc 32. To activate the friction coupling, the bistable lifting magnet is transferred into the second position by a current impulse. The loop spring 30 is thereby tightened, comes in contact with the coupling disc 32 and thus exerts the necessary braking force for activation of the friction coupling. The deactivation of the friction coupling takes place by a reversed current impulse. The switching processes are able to be carried out without constantly providing the bistable lifting magnet with current.

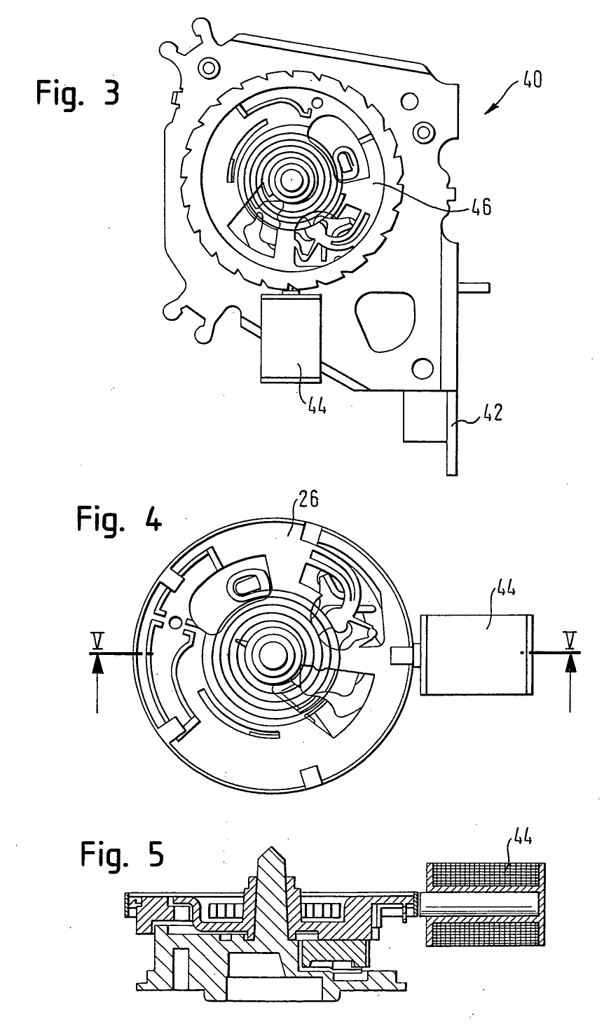

The use of an impulse-controlled actor in the example of a locking system in an electric belt retractor 40 is described with the aid of FIGS. 3 to 5. The belt retractor and its mode of operation are known per se from published German Utility Model DE 202 11 786, so that only the characteristics that are essential to the invention are entered into in detail here.

Instead of an electromagnet, a bistable lifting magnet 44 is provided on the frame 42 of the belt retractor 40. The bistable lifting magnet 44 is arranged such that it arrests the coupling disc 46 in its second position. The vehicle-sensitive locking can be realized by a toothed coupling disc 46 or may also be realized by friction contact. A design with an intermediate lever may likewise be provided, which receives the braking forces in order to relieve the plunger of the bistable lifting magnet of any transverse forces.

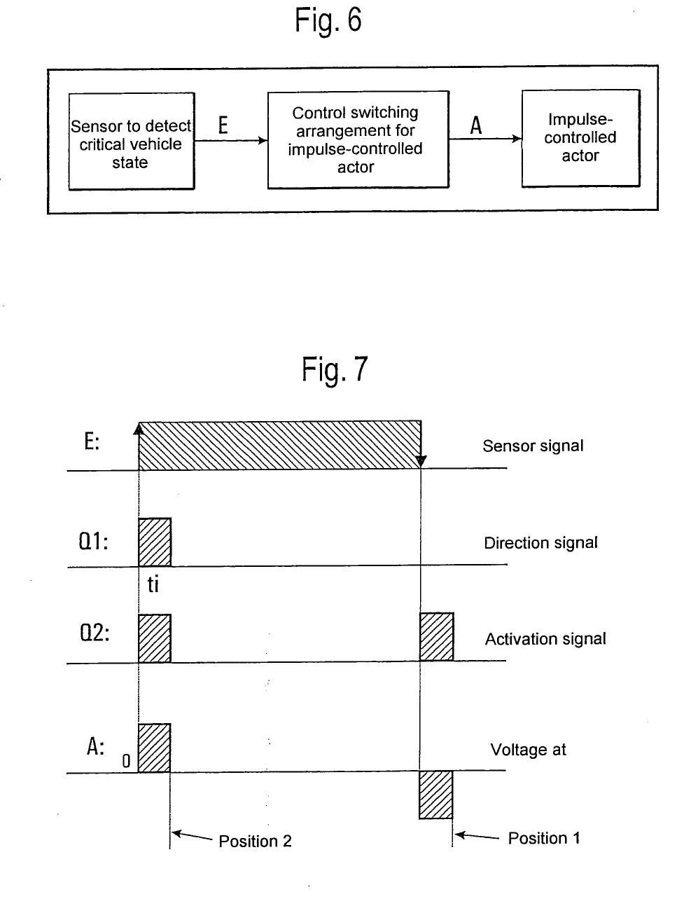

FIGS. 6 and 7 show an example block diagram for a safety device according to the invention in a vehicle occupant restraint system, and an associated function diagram. One or more sensors determine whether a critical vehicle state exists. With a corresponding sensor signal, a controlling circuit arrangement is activated for the impulse-controlled actor. At the onset of the critical vehicle state, the controlling circuit arrangement generates a direction signal Q1 and an activation signal Q2. On the basis of these two signals, a voltage impulse A is applied to the actor. In the case of a bistable lifting magnet, its plunger is moved from the first position into the second position in unison with the direction signal Q1, and thereby transfers the safety device from a first state into a second state (e.g. blocking of the belt spool of a belt retractor). If the sensor signal and hence the critical state of the vehicle are no longer present, a further activation signal Q2 is generated. As, in this case, no direction signal Q1 was generated, a voltage impulse with reversed sign is applied to the actor, such that the safety device is transferred into the first state again (e.g. release of the belt spool).

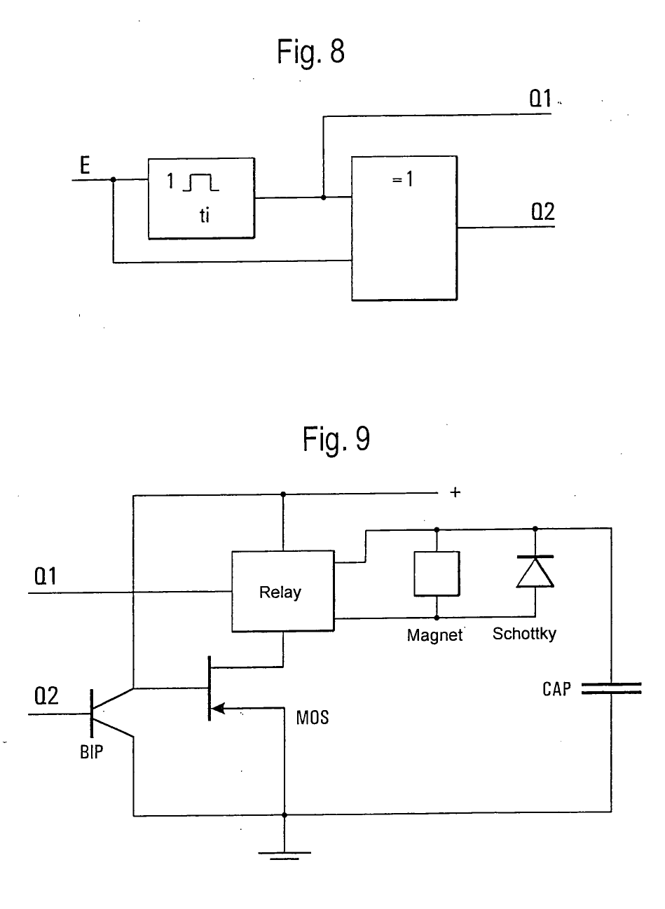

FIGS. 8 and 9 show switching examples for a logic part and an output part of a controlling circuit arrangement. A monostable tilting stage is used to generate a voltage impulse of the length ti. The activation signal Q2 is obtained according to FIG. 8 as “XOR” (Exclusive-Or). The output signals Q1 and Q2 of the logic part form the control signals for the output part. The relay serves to set the direction of movement of the impulse-controlled actor.

1. A safety device for a vehicle occupant restraint system, the safety device being able to be transferred from a first state into a second state, an impulse-controlled actor being provided to transfer the safety device from the first state into the second state.

2. The safety device according to claim 1, wherein the actor is a linear adjustment drive with a bistable lifting magnet.

3. The safety device according to claim 1, wherein the safety device is part of a safety belt system.

4. The safety device according to claim 3, wherein the impulse-controlled actor is part of a friction coupling for an electric belt retractor.

5. The safety device according to claim 3, wherein the impulse-controlled actor is part of a locking system in an electric belt retractor.
